(19) United States
(12) Patent Application Publication
(10) Pub. No.: US 2006/0242305 A1
(43) Pub. Date: Oct. 26, 2006

(54) VPN Proxy Management Object

(75) Inventor: Svante Alnas, SE-224 68 Lund (SE)

Correspondence Address: POTOMAC PATENT GROUP, PLLC, P. O. BOX 270, FREDERICKSBURG, VA, 22404, US

(73) Assignee: Telefonaktiebolaget L M Ericsson (publ), Stockholm (SE)

(21) Appl. No.: 11/379,475

(22) Filed: Apr. 20, 2006

Related U.S. Application Data
(60) Provisional application No. 60/674,637, filed on Apr. 25, 2005.

(51) Int. Cl. G06F 15/16

(52) U.S. Cl. 709/227

(57) ABSTRACT

Current specifications/proposals use client provisioning or device management for provisioning bearer-specific configuration and application-specific configuration of communication devices. A proxy management object (MO) can, for example, set up tunnels according to particular protocols between application MOs and a generic connectivity MO. A communication device's application configuration can then refer to such a proxy MO, and the proxy MO can refer to the connectivity MO. This enables addition of functionality like virtual private network and wireless local area network functionality without affecting the connectivity MO or the different application MOs.

This application claims the benefit of U.S. Provisional Patent Application No. 60/674,637 filed on Apr. 25, 2005, the content of which is incorporated here by reference.

### BACKGROUND

The Open Mobile Alliance (OMA) has developed specifications for Device Management (DM) in communication devices, and versions 1.1.2 and 1.2 of those specifications define a protocol for managing configuration, data, and settings in communication devices. OMA standards and other information are available at http://www.openmobilealliance.org.

DM relates to management of device configuration and other Management Objects (MOs) of devices from the point of view of different DM Authorities, and includes, but is not restricted to, setting initial configuration information in devices, subsequent updates of persistent information in devices, retrieval of management information from devices, and processing events and alarms generated by devices. Using such DM, third parties can configure communication devices on behalf of end users. A third party, such as a network operator, service provider, and corporate information management department, can remotely set parameters, troubleshoot terminals, and install or upgrade software.

An application, such as a web browser, in a communication device has respective Settings in different MOs, which in general are variously sized information entities that can be manipulated by management actions. For example, an MO may be written according to SyncML, which is a mark-up language specification of an XML-based representation protocol, synchronization protocol, and DM protocol, transport bindings for the protocols, and a device description framework for DM.

A communication device can, for example, use a Connectivity MO for application-independent settings to connect to a network, such as a wireless application protocol (WAP) network. A Connectivity MO for such a network would provide connectivity information that relates to the parameters and means needed to access the WAP infrastructure, including network bearers, protocols, Network Access Point (NAP) addresses, and proxy addresses. Connectivity MOs are described in “DM Connectivity Management Objects”, http://www.openmobilealliance.org/ftp/Public_documents/TP/Permanent_documents/OMA-WID_{—}0123-ConnectivityMO-V1_{—}0-20051004-A.zip, OMA (Oct. 7, 2005).

A NAP is a physical interface point between a wireless network and a fixed network and can be a remote access server (RAS), a short message service center (SMSC), an unstructured supplementary service data center (USSDC), or the like, which has an address (e.g., a telephone number) and an access bearer.

A WAP proxy is an endpoint for the wireless transport protocol (WTP), the wireless session protocol (WSP), and the wireless transport layer security (WTLS) protocol, as well as a proxy that is able to access WAP content. A WAP proxy can have functionality such as that of, for example, a wireless session protocol (WSP) proxy or a wireless telephony application (WTA) proxy. A physical proxy is a specific address with proxy functionality, e.g., an internet protocol (IP) address plus port for an IP-accessible proxy, and a short message entity (SME)-address plus port for an SMS-accessible proxy. A logical proxy is a set of physical proxies that may share the same WSP and WTLS context (shared session identification value space).

According to OMA specifications, a Connectivity MO enabler handles management of wireless data connectivity by specifying a set of DM object schema that may be exposed by a DM client and targeted by a DM server. The object schema have three parts: a top level management object that is bearer-neutral; a set of bearer-specific parameters; and a sub-tree for exposing vendor-specific parameters. Connectivity parameters bootstrapped using Client Provisioning (CP) can be subsequently addressed and managed through the DM server, which can add new proxies and NAPs using a standardized DM package. Provisioning is the process by which a client, such as a WAP client in a device, is configured, and generally covers both over the air (OTA) provisioning and other provisioning, e.g., by a subscriber identity module (SIM) card.

As depicted in FIG. 1, a DM Authority 102 issues a request to a DM Server 104 to provision data connectivity parameters in one or more devices. The DM Server 104 sends a Server-initiated Notification to the communication device 106, and the device 106 establishes a session with the DM Server 104, which queries the device for current settings (including any device-specific extensions). The DM Server 104 sends DM commands to adjust the device's configuration to conform to requirements established by the DM Authority 102. The device 106 and DM Server 104 end their management session, and the device is able to access network data services using the configured connectivity parameters. The DM Authority or the DM Server may also store the connectivity parameters on a “smart card” or the like so that the device will use them when the device is consuming the parameters.

Until recently, the typical communication device, or user equipment (UE), such as a mobile phone, in a communication system has not supported virtual private networks (VPNs). Such functionality is becoming increasingly important as more and more UEs are integrated mobile phones and computing devices, such as personal digital assistants (PDAs) and other “smart phones”. Current specifications and proposals do not include how to connect to a network via VPN tunnels, for example.

### SUMMARY

Current specifications/proposals use CP or DM for provisioning bearer-specific configuration and application-specific configuration. This patent application describes a MO that can, for example, set up a VPN tunnel. A communication device's application configuration can then refer to such a “VPNProxy” MO, and the VPNProxy MO refers to the Connectivity MO. This enables addition of functionality like VPN functionality without affecting the Connectivity MO or the different application MOs.

In accordance with an aspect of this invention, there is provided a method of operating a communication device. The method includes the steps of providing at least one application MO; providing a Connectivity MO through which application MOs can communicate; and functionally disposing a Proxy MO between the application MOs and the Connectivity MO. The Proxy MO facilitates communication by at least one of the application MOs through the Connectivity MO.

In accordance with another aspect of this invention, there is provided an apparatus in a communication device. The apparatus includes a programmable processor configurable to execute instructions according to MOs; at least one application MO; a Connectivity MO through which application MOs can communicate; and a Proxy MO functionally disposed between the application MOs and the Connectivity MO. The Proxy MO facilitates communication by at least one of the application MOs through the Connectivity MO.

In accordance with another aspect of this invention, there is provided a computer-readable medium containing a computer program for operating a communication device. The computer program implements the steps of providing at least one application management object; providing a connectivity management object through which application management objects can communicate; and functionally disposing a proxy management object between the application management objects and the connectivity management object. The proxy management object facilitates communication by at least one of the application management objects through the connectivity management object.

### BRIEF DESCRIPTION OF THE DRAWINGS

The features, advantages, and objects of this invention will be understood by reading this description in conjunction with the drawings, in which:

FIG. 1 is a block diagram illustrating provisioning for a communication device;

FIG. 2 depicts relationships among application management objects, a VPNProxy management object, and a connectivity management object;

FIG. 3 illustrates an arrangement of a VPNProxy management object;

FIG. 4 is a block diagram of a communication system;

FIG. 5 is a block diagram of a communication device; and

FIG. 6 is a flow chart of a method of operating a communication device.

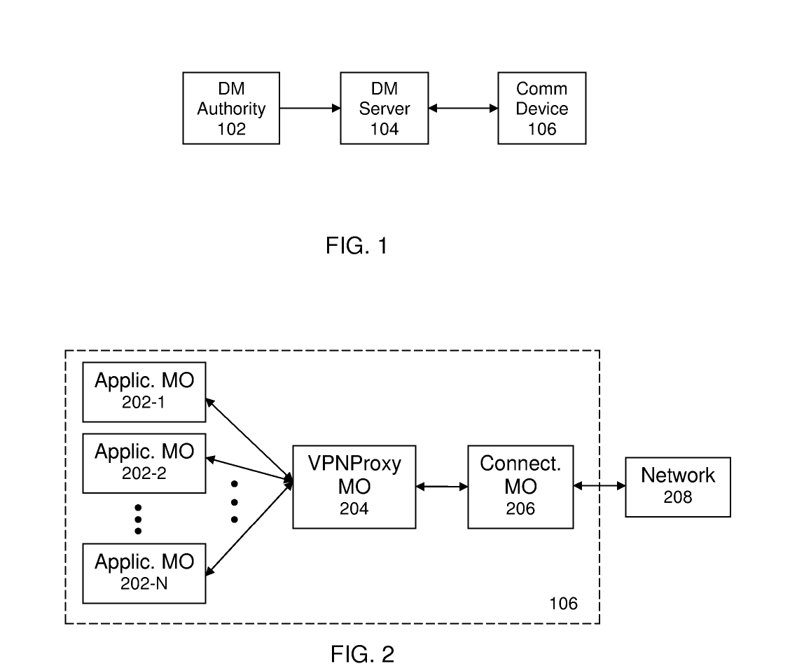

### DETAILED DESCRIPTION

As described in this patent application, a Proxy MO is added in a communication device between an application MO and a Connectivity MO that facilitates communication by the application through the Connectivity MO. In general, a Proxy MO facilitates configuring network proxies of various kinds and is bearer-neutral but may include parameters specific to particular proxy types. The Proxy MO described below can, for example, set up a VPN tunnel for the application MO through the Connectivity MO.

As an initial matter, the Connectivity MO in the UE is configured with any necessary configurations for setting up network connectivity to an operator's network by the usual CP procedures or DM procedures. These settings may include, for example, how to get IP-connectivity. Different applications resident in a communication device have respective MOs that contain only respective configurations of the different applications, which may include for example a web browser, e-mail reader, news reader, etc.

FIG. 2 depicts the relationships among a plurality of application MOs 202-1, 202-2, . . . , 202-N, a VPNProxy MO 204, and a Connectivity MO 206 that may be disposed in a communication device 106. The VPNProxy MO makes it possible, for example, for applications to use Point-to-Point Tunnelling Protocol (PPTP) or Layer 2 Tunnelling Protocol (L2TP) tunnels to reach services in a network 208 through the Connectivity MO 206. The configuration 204 as described here is preferably a separate MO, independent of the Connectivity MO and the applications MOs.

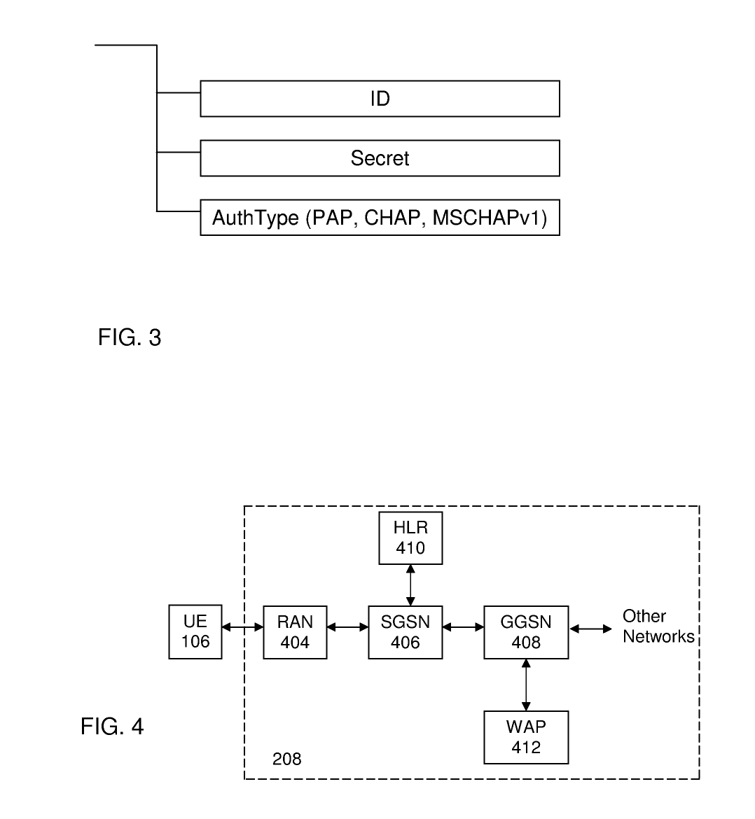

It will be appreciated that, at least in principle, the configuration 204, such as VPN configuration, could be provided in other ways that will be apparent to those of ordinary skill in this art. For example, this kind of proxy MO can be readily constructed according to the OMA standards as a separate MO specification. FIG. 3 illustrates a basic arrangement of a VPNProxy MO 204, including an identification node ID, an encryption node Secret, and an authorization method type node AuthType. Exemplary authorization method types are password or packet authentication protocol (PAP), Challenge-Handshake Authentication Protocol (CHAP), and versions of the Microsoft Challenge Handshake Authentication Protocol (MSCHAP).

With a Proxy MO 204, it is possible to add functionality, such as VPN functionality, without affecting the Connectivity MO and the different applications MOs. This is important because the application configuration does not contain any bearer-specific configuration information.

It is also advantageous that the Proxy MO 204 is user-friendly in that the users need not bother about connectivity settings. Until now, the UE has not supported VPN connectivity but as the functionality of UEs increases, such user friendliness becomes increasingly valuable.

Another advantage is that such a Proxy MO 204 can be dynamic, making it possible to add settings, such as VPN settings, for new applications and also to re-configure the VPN settings for existing applications during their life cycles. For example, a device may be able to change the connectivity it uses with each application, i.e., a connectivity profile can be selected for use with, say, a web browser. In such a case, an application's settings can be changed to select a different VPN tunnel to use. In that way, the linkages between application MOs, VPN MOs, and Connectivity MOs are dynamic, while the content of the VPN MO is substantially static. And as described above, the VPN configuration can contain the needed configuration for setting up both a PPTP and L2TP tunnel.

Connectivity profiles can be configured and changed by a number of different actors, including an enterprise, operator, end-user, etc. The UE can also implement logic that automatically maps different applications to different VPN Proxies and connectivity. One or more profiles can be stored in the UE's memory, where a profile is a group of one or more settings, and a profile can be selected by recalling the respective group of settings from the memory.

FIG. 4 is a block diagram of a communication system that can employ UEs having the Proxy MOs described in this application. It will be understood that the UE may also connect to a network such as the internet via wireless local area networking (WLAN) such as IEEE 802.11, WiMAX (IEEE 802.16), etc., and in addition to the blocks shown in FIG. 4, the UE may use a 3GPP interworking WLAN. A UE 106 communicates with a network 208, which typically includes a radio access network (RAN) 404, such as a GSM/EDGE network, and core-network entities, including a servicing GPRS support node (SGSN) 406, a gateway GPRS support node (GGSN) 408, and a home location register (HLR) 410. The GGSN 308 communicates with other networks, such as the internet and public switched telephone networks, and other entities, such as a WAP infrastructure 412. The RAN 404 typically includes one or more base stations (BSs) and base station controllers, or Node Bs and radio network controllers (RNCs), that are conventional. The RNCs control various radio network functions, including for example radio access bearer setup, diversity handover among BSs, etc. More generally, each RNC directs calls to and from a UE via the appropriate BSs, which communicate with each other through downlink (i.e., base-to-mobile or forward) and uplink (i.e., mobile-to-base or reverse) channels. Each BS serves a geographical area that is divided into one or more cell(s) and is typically coupled to its corresponding RNC by dedicated telephone lines, optical fiber links, microwave links, etc. The core-network entities are adapted to handle many types of data. In a typical GSM/EDGE network, packet data protocol (PDP) contexts for administering data flows are set up, or activated, in the GGSN 408 in response to requests from the UE 106. It will be understood that a UE can also connect to the network via wireless local area network access.

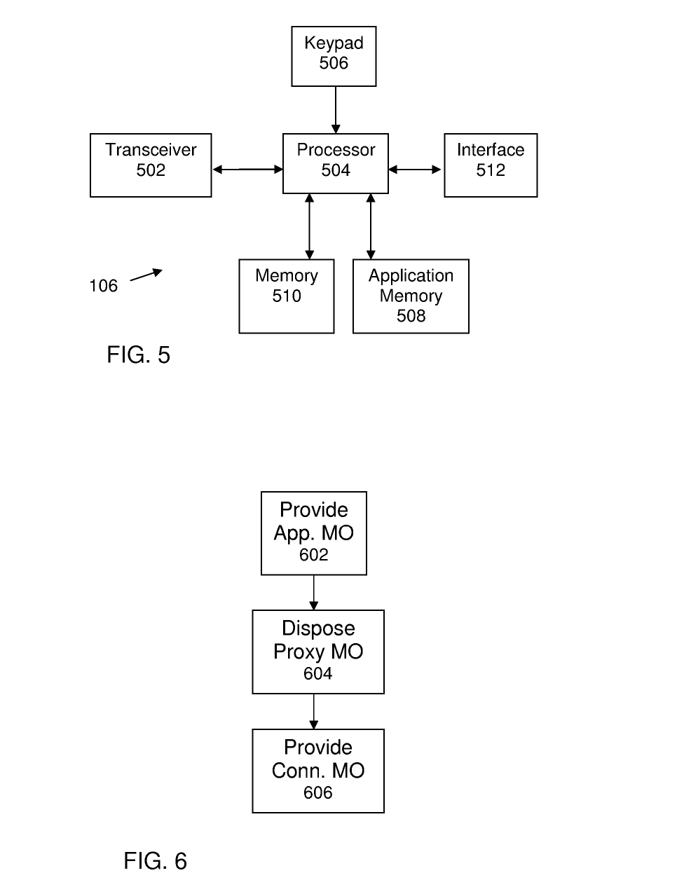

FIG. 5 is a block diagram of a communication device 106, including a suitable transceiver 502 for exchanging radio signals with BSs in the RAN 404. Information carried by those signals is handled by a processor 504, which may include one or more sub-processors, and which executes one or more software applications to carry out the operations of the device 106 according to the MOs described above. User input to the terminal is provided through a keypad 506 or other device. Software applications may be stored in a suitable application memory 508, and the device may also download and/or cache desired information in a suitable memory 510. The device 106 also includes an interface 512 that can be used to connect other components, such as a computer, keyboard, etc., to the device 106.

FIG. 6 is a flow chart of a method of operating a communication device with a VPN Proxy as described above. At least one application MO is provided in the device (step 602), and a Connectivity MO is also provided in the device (step 606). An application MO can communicate using the Connectivity MO. In step 604, a Proxy MO is functionally disposed between the application MO(s) and the Connectivity MO. The Proxy MO facilitates communication by at least one of the application MOs through the Connectivity MO. As described above, the Proxy MO can facilitate communication by an application MO through a VPN connection established through the Connectivity MO. The VPN connection may include a tunnel according to a protocol such as the PPTP and L2TP protocol the connectivity management object.

The invention described here can be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

It is expected that this invention can be implemented in a wide variety of environments, including for example mobile communication devices. It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action. It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of operating a communication device, comprising the steps of:
providing at least one application management object;
providing a connectivity management object through which application management objects can communicate; and
functionally disposing a proxy management object between the application management objects and the connectivity management object, wherein the proxy management object facilitates communication by at least one of the application management objects through the connectivity management object.

2. The method of claim 1, wherein the proxy management object facilitates communication by an application management object through a virtual private network (VPN) connection established through the connectivity management object.

3. The method of claim 2, wherein the VPN connection includes a tunnel according to one of a point-to-point tunnelling protocol and a layer 2 tunnelling protocol through the connectivity management object.

4. The method of claim 3, wherein the proxy management object comprises an identification node, an encryption node, and an authorization method type node.

5. The method of claim 4, wherein the authorization method type node comprises at least one of a password or packet authentication protocol, a Challenge-Handshake Authentication Protocol, and a Microsoft Challenge Handshake Authentication Protocol.

6. The method of claim 1, wherein the proxy management object facilitates communication by at least one of the application management objects through the connectivity management object by changing connectivity used by the device for a respective application.

7. The method of claim 6, wherein changing connectivity comprises selecting at least one setting to be used by the respective application.

8. The method of claim 7, wherein the respective application is a web browser.

9. An apparatus in a communication device, comprising:
a programmable processor configurable to execute instructions according to management objects;
at least one application management object;
a connectivity management object through which application management objects can communicate; and
a proxy management object functionally disposed between the application management objects and the connectivity management object, wherein the proxy management object facilitates communication by at least one of the application management objects through the connectivity management object.

10. The device of claim 9, wherein the proxy management object facilitates communication by an application management object through a virtual private network (VPN) connection established through the connectivity management object.

11. The device of claim 10, wherein the VPN connection includes a tunnel according to one of a point-to-point tunnelling protocol and a layer 2 tunnelling protocol through the connectivity management object.

12. The device of claim 11, wherein the proxy management object comprises an identification node, an encryption node, and an authorization method type node.

13. The device of claim 12, wherein the authorization method type node comprises at least one of a password or packet authentication protocol, a Challenge-Handshake Authentication Protocol, and a Microsoft Challenge Handshake Authentication Protocol.

14. The device of claim 9, wherein the proxy management object changes a connectivity used by the device for a respective application.

15. The device of claim 14, wherein the device further comprises a memory, and the connectivity is changed by selecting at least one setting to be used by the respective application.

16. The device of claim 15, wherein the respective application is a web browser.

17. A computer-readable medium containing a computer program for operating a communication device, the computer program implementing the steps of:
providing at least one application management object;
providing a connectivity management object through which application management objects can communicate; and
functionally disposing a proxy management object between the application management objects and the connectivity management object, wherein the proxy management object facilitates communication by at least one of the application management objects through the connectivity management object.

18. The computer-readable medium of claim 17, wherein the proxy management object facilitates communication by an application management object through a virtual private network (VPN) connection established through the connectivity management object.

19. The computer-readable medium of claim 18, wherein the VPN connection includes a tunnel according to one of a point-to-point tunnelling protocol and a layer 2 tunnelling protocol through the connectivity management object.

20. The computer-readable medium of claim 17, wherein the proxy management object facilitates communication by at least one of the application management objects through the connectivity management object by changing connectivity used by the device for a respective application.
